(19) United States
(12) Patent Application Publication
(10) Pub. No.: US 2018/0223733 A1
(43) Pub. Date: Aug. 9, 2018

(54) ACOUSTIC TREATMENT ASSEMBLY FOR A TURBINE SYSTEM

(71) Applicants: Hua ZHANG, Greenville, SC (US); David Wesley BALL, Greenville, SC (US); Qunjian HUANG, Shanghai (CN); Richard Lynn LOUD, New York, NY (US); General Electric Company, Schenectady, NY (US)

(72) Inventors: Hua ZHANG, Greer, SC (US); David Wesley BALL, JR., Easley, SC (US); Qunjian HUANG, Shanghai (CN); Richard Lynn LOUD, Ballston Spa, NY (US)

(21) Appl. No.: 15/507,987

(22) PCT Filed: Sep. 3, 2014
(86) PCT No.: PCT/CN2014/085808

§ 371 Date: Mar. 1, 2017

(51) Int. Cl. F02C 7/045; F01D 25/30; F02M 35/12

(52) U.S. Cl. CPC F02C 7/045; F05D 2260/96; F02M 35/1255; F01D 25/30

(57) ABSTRACT

An acoustic treatment assembly (50) for a turbine system includes a region of the turbine system having a flow path configured to allow a fluid flow therethrough. Also included is at least one sound attenuation structure (52) disposed in the flow path. The sound attenuation structure includes a substantially rigid frame (54) and a flexible membrane (56) retained by the frame.

### BACKGROUND OF THE INVENTION

The subject matter disclosed herein relates to turbine systems and, more particularly, an acoustic treatment assembly for attenuating sound in turbine systems.

Turbine systems typically generate significant noise during operation. The noise levels may be regulated in certain environments and compliance with such regulations typically requires costly and often inefficient solutions. For example, silencer panels may be employed at various locations of the turbine system, such as within an inlet duct. The material and geometry of the silencer panels drive the absorption characteristics associated with dampening sound. Often, frequencies associated with operation of the turbine system require thicker, or longer, silencer panels to adequately dampen the sound. Lengthening the silencer panels results in more expensive panels due to the additional required material. Furthermore, longer panels undesirably increase the overall length (i.e., footprint) of the turbine system.

### BRIEF DESCRIPTION OF THE INVENTION

According to one aspect of the invention, an acoustic treatment assembly for a turbine system includes a region of the turbine system having a flow path configured to allow a fluid flow therethrough. Also included is at least one sound attenuation structure disposed in the flow path. The at least one sound attenuation structure includes a substantially rigid frame. The at least one sound attenuation structure also includes a flexible membrane retained by the substantially rigid frame.

According to another aspect of the invention, an inlet region of a gas turbine engine includes an inlet flow path. Also included is at least one sound attenuation structure disposed in the flow path of the inlet region. The at least one sound attenuation structure includes a substantially rigid frame divided into at least one cell. The at least one sound attenuation structure also includes at least one flexible membrane retained by the substantially rigid frame. The at least one sound attenuation structure further includes a mass operatively coupled to the at least one flexible membrane, wherein an absorption characteristic of the at least one sound attenuation structure is adjustable based on a weight of the mass, a flexibility of the at least one flexible membrane and a geometry of the substantially rigid frame.

According to yet another aspect of the invention, a diffuser of a gas turbine engine includes an exhaust flow path. Also included is at least one sound attenuation structure disposed in the exhaust flow path. The at least one sound attenuation structure includes a substantially rigid frame divided into at least one cell. The at least one sound attenuation structure also includes at least one flexible membrane retained by the substantially rigid frame. The at least one sound attenuation structure further includes a mass operatively coupled to the at least one flexible membrane, wherein an absorption characteristic of the at least one sound attenuation structure is adjustable based on a weight of the mass, a flexibility of the at least one flexible membrane and a geometry of the substantially rigid frame.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is a side elevational view of an inlet region of the gas turbine engine;

FIG. 3 is a side, cross-sectional view of of sound attenuating structures within the gas turbine engine;

FIG. 4 is cross-sectional view of a strut having the sound attenuating structures thereon according to line 4-4 of FIG. 3; and

FIG. 5 is a view of the sound attenuating structure.

The detailed description explains embodiments of the invention, together with advantages and features, by way of example with reference to the drawings.

### DETAILED DESCRIPTION OF THE INVENTION

The terms “axial” and “axially” as used in this application refer to directions and orientations extending substantially parallel to a center longitudinal axis of a turbine system. The terms “radial” and “radially” as used in this application refer to directions and orientations extending substantially orthogonally to the center longitudinal axis of the turbine system. The terms “upstream” and “downstream” as used in this application refer to directions and orientations relative to an axial flow direction with respect to the center longitudinal axis of the turbine system.

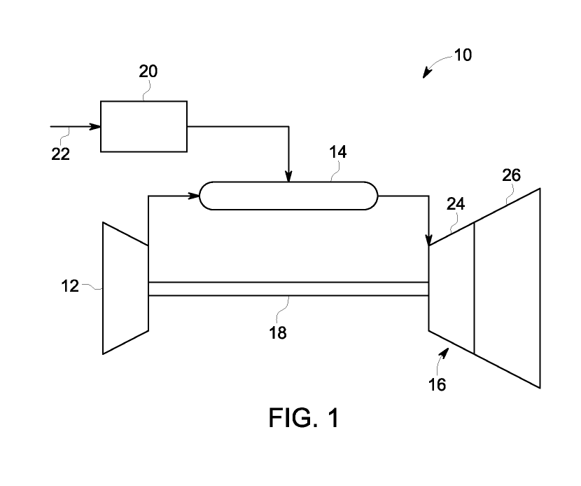

Referring to FIG. 1, a turbine system, such as a gas turbine engine, for example, is schematically illustrated and generally referred to with reference numeral 10. The gas turbine engine 10 includes a compressor section 12, a combustor section 14, a turbine section 16, a shaft 18 and a fuel nozzle 20. It is to be appreciated that one embodiment of the gas turbine engine 10 may include a plurality of compressors 12, combustors 14, turbines 16, shafts 18 and fuel nozzles 20. The compressor section 12 and the turbine section 16 are coupled by the shaft 18. The shaft 18 may be a single shaft or a plurality of shaft segments coupled together to form the shaft 18.

The combustor section 14 uses a combustible liquid and/or gas fuel, such as natural gas or a hydrogen rich synthetic gas, to run the gas turbine engine 10. For example, fuel nozzles 20 are in fluid communication with an air supply and a fuel supply 22. The fuel nozzles 20 create an air-fuel mixture, and discharge the air-fuel mixture into the combustor section 14, thereby causing a combustion that creates a hot pressurized exhaust gas. The combustor section 14 directs the hot pressurized gas through a transition piece into a turbine nozzle (or “stage one nozzle”), and other stages of buckets and nozzles causing rotation of turbine blades within an outer casing 24 of the turbine section 16. Subsequently, the hot pressurized gas is sent from the turbine section 16 to an exhaust diffuser 26 that is operably coupled to a portion of the turbine section, such as the outer casing 24, for example

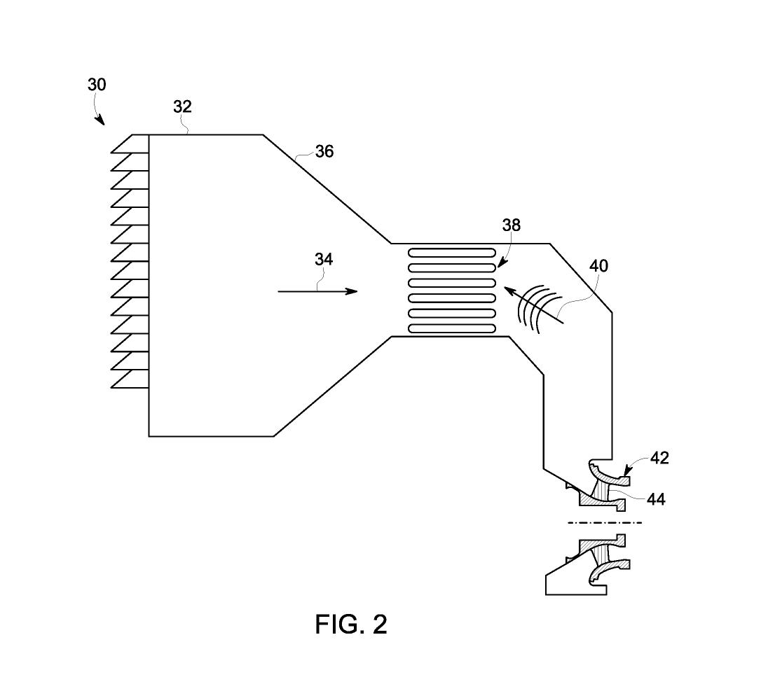

Referring to FIG. 2, an inlet region 30 of the gas turbine engine 10 includes a main inlet portion 32 configured to receive an airflow 34 traveling predominantly in a first direction. The airflow 34 travels from the main inlet portion 32 through a transition duct 36 that narrows in a downstream direction and into various other portions of the inlet region 30. A silencer assembly 38 is disposed within the inlet region 30 and functions to dampen the sound associated with propagatingsound waves 40 that are generated by the compressor section 12, and gas turbine engine 10 itself, as the airflow 34 passes through them. The sound waves 40 travel substantially opposite in direction to the airflow 34 and thereby interact with the silencer assembly 38 disposed within the inlet region 30.

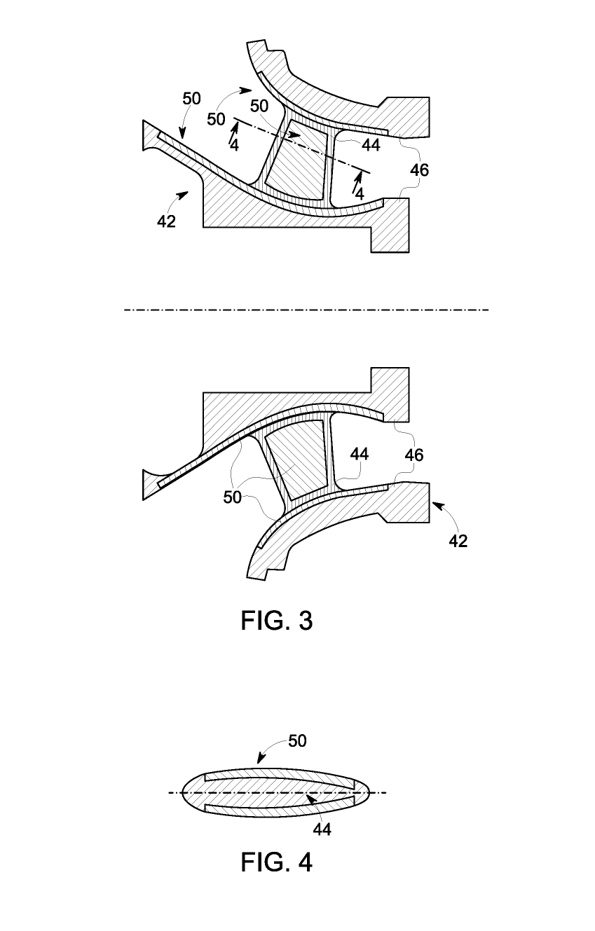

Referring now to FIGS. 2-4, thenoise is generated proximate an inlet to the compressor section 12 of the gas turbine engine 10. Located adjacent the inlet to the compressor section 12 is a compressor bell mouth 42. To dampen the noise generated in this region, an acoustic treatment assembly 50 is disposed within the compressor bell mouth 42. More specifically, the acoustic treatment assembly 50 is disposed in an airflow path of the compressor bell mouth 42. Although described as being located within the compressor bell mouth 42, it is to be appreciated that the acoustic treatment assembly 50 may be located in numerous other locations of the gas turbine engine 10, such as any portion of the inlet region 30 or proximate the exhaust diffuser 26 located downstream of the turbine section 16. As shown, the acoustic treatment assembly 50 may be disposed on numerous locations of the compressor bell mouth 42, such as on a strut 44 and inner wall regions 46 of the compressor bell mouth 42.

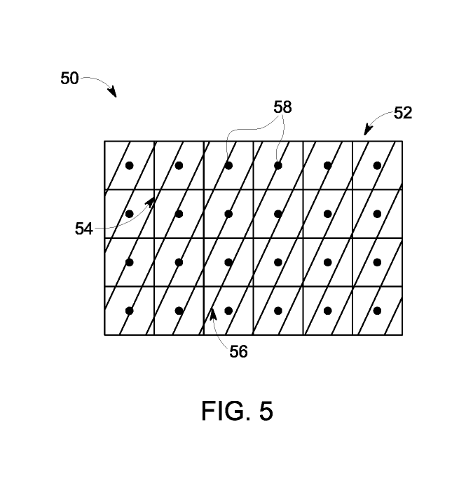

Referring to FIG. 5, the acoustic treatment assembly 50 is formed as a sound attenuation structure 52 having an adjustable resonant frequency configured to dampen sound waves passing by. The adjustable resonant frequency may be tuned by an operator based on the blade passing frequency of the gas turbine engine 10. The sound attenuation structure 52 includes a substantially rigid frame 54 that is formed of numerous suitable materials. Typically, a metal suitable for sustaining the operating conditions of the gas turbine engine 10 is employed. The substantially rigid frame 54 may be formed in numerous grid-like geometries. In the illustrated embodiment, the substantially rigid frame 54 includes a grid comprising severalregions that have mass 58 in certain geometries such as semi-circular, oval or other shapes, in symmetrical or asymmetrical arrangements.

The substantially rigid frame 54 comprises two or more panels that sandwich and retain a flexible membrane 56 therebetween. The flexible membrane 56 may be formed of any flexible and durable material, such as steel, for example. In one embodiment, a plurality of flexible membranes is included. A mass 58 operatively coupled to the flexible membrane 56 is also included.

The structure described can be regarded as composed of two components: the mass m of an oscillator, and the spring K of an oscillator. To tune the oscillation to target certain frequencies for treatment, both or either mass m and spring K can be selected. However, structural integrity of the panels should be considered when matching the mass m and spring K. Consider the usual mass-spring geometry whereby the mass displacement x is equal to the spring displacement, so that the restoring force is given by K*x. Consider the case in which the mass displacement is transverse to the spring. In that case the mass displacement x will cause a spring elongation in the amount of (1/2)*l*(x/l)²=x²/2l, where l is the length of the spring. Thus the restoring force is given by Kx*(x/2l). Since x is generally very small, the effective spring constant K′=K*(x/2l) is thus significantly reduced. As the local oscillator's resonance frequency is given by:

$$f = \frac{1}{2 π} \sqrt{\frac{{K}^{′}}{m}}$$

Adjusting K′ and m can effectively change the resonance frequency. A weak effective K′ would yield a very low resonance frequency, and vice versa. Thus, a relatively lighter mass m in the embodiments described herein while still achieving the same effect.

The above discussion is for extreme cases where the diameter of the spring, or rather that of an elastic rod, is much smaller than its length l. When the diameter is comparable to l, the restoring force is proportional to the lateral displacement x and the force constant K′ would hence be independent of x. For medium-range diameters K′ changes gradually from independent of x to linearly dependent on x, i.e., the x-independent region of the displacement gradually shrinks to zero. In two-dimensional configurations, this corresponds to a mass on an elastic membrane with thickness ranging from much smaller than the lateral dimension to comparable to it. The effective force constant K′ depends on the actual dimensions of the membrane as well as the tension on the elastic membrane. All these parameters can be adjusted to obtain the desired K′ to match the given mass, so as to achieve the required resonance frequency. For example, to reach higher resonance frequency one could use either lighter weights, or increase the K′ of the membrane by stacking two or more membranes together, the effect of which is the same as using a single but thicker membrane. The resonance frequency may also be adjusted by varying the tension in the membrane when it is secured to the rigid grid. For example if the tension of the membrane is increased then the resonance frequency will also increase.

The three main components of the sound attenuation structure 52, namely the substantially rigid frame 54, the flexible membrane 56, and the mass 58 may be characterized in terms of the oscillator described above. The flexible membrane56 (provides a structure onto which the mass 58 can be fixed. The mass 58 and flexible membrane act as the local resonators.The substantially rigid frame 54 itself is almost totally transparent to sound waves. The flexible membrane 56, which is fixed to the substantially rigid frame 54 serves as the spring in a spring-mass local oscillator system.

The flexible membrane 56 may be a single sheet that covers multiple cells of the substantially rigid frame 54, or each cell may be formed with an individual flexible membrane attached to the frame. Multiple flexible membranes may also be provided superimposed on each other, for example two thinner sheets could be used to replace one thicker sheet. The tension in the flexible membrane 56 can also be varied to affect the resonant frequency of the system.

The resonance frequency (natural frequency) of the system is determined by the mass m and the effective force constant K of the flexible membrane 56, which is equal to the membrane elasticity times a geometric factor dictated by the size of the cell and the thickness of the membranesheet, in a simple relation. In this way the absorption characteristics of the sound attenuation structure 52 may be adjusted based on the flexibility of the flexible membrane 56, the weight of the mass 58 and the geometry of the substantially rigid frame 54.

Advantageously, the acoustic treatment assembly 50 selectively absorbs various frequency ranges of acoustical energy, thereby allowing the silencer panels of the silencer assembly 38 to be simplified. Simplification may include shortening the panels based on the reduction in acoustical energy absorption requirements of the panels. Such an arrangement reduces the overall length of the turbine system and increases the efficiency of sound attenuation.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An acoustic treatment assembly for a turbine system comprising:
a region of the turbine system having a flow path configured to allow a fluid flow therethrough; and
at least one sound attenuation structure disposed in the flow path, the at least one sound attenuation structurecomprising:
a substantially rigid frame; and
a flexible membrane retained by the substantially rigid frame.

2. The acoustic treatment assembly of claim 1, further comprising a plurality of flexible membranes retained by the substantially rigid frame.

3. The acoustic treatment assembly of claim 1, wherein the flexible membrane comprises steelsheets.

4. The acoustic treatment assembly of claim 1, wherein the at least one sound attenuation structure further comprises a mass operatively coupled to the flexible membrane.

5. The acoustic treatment assembly of claim 4, wherein an absorption characteristic of the at least one sound attenuation structure is adjustable.

6. The acoustic treatment assembly of claim 5, wherein the absorption characteristic comprises a resonant frequency.

7. The acoustic treatment assembly of claim 5, wherein the absorption characteristic is adjustable based on a weight of the mass.

8. The acoustic treatment assembly of claim 5, wherein the absorption characteristic is adjustable based on a flexibility of the flexible membrane.

9. The acoustic treatment assembly of claim 5, wherein the absorption characteristic is adjustable based on a geometry of the substantially rigid frame.

10. The acoustic treatment assembly of claim 1, wherein the region of the turbine system comprises an inlet region of a gas turbine engine.

11. The acoustic treatment assembly of claim 10, wherein the region comprises a bell mouth structure disposed proximate an inlet of a compressor section of the gas turbine engine.

12. The acoustic treatment assembly of claim 1, wherein the region of the turbine system comprises an exhaust region of a gas turbine engine.

13. The acoustic treatment assembly of claim 12, wherein the region comprises an exhaust diffuser.

14. Aninlet region of a gas turbine engine comprising:
an inlet flow path;
at least one sound attenuation structure disposed in the flow path of the inlet region, the at least one sound attenuation structure comprising:
a substantially rigid frame divided into at least one cell;
at least one flexible membrane retained by the substantially rigid frame; and
a mass operatively coupled to the at least one flexible membrane, wherein an absorption characteristic of the at least one sound attenuation structure is adjustable based on a weight of the mass, a flexibility of the at least one flexible membrane and a geometry of the substantially rigid frame.

15. The inlet region of claim 14, wherein the at least one flexible membrane comprises steel sheets.

16. The inlet region of claim 14, wherein the absorption characteristic comprises a resonant frequency of the at least one sound attenuation structure.

17. The inlet region of claim 14, wherein the absorption characteristic is further adjustable based on a flexibility of the at least one flexible membrane and a geometry of the substantially rigid frame.

18. A diffuser of a gas turbine engine comprising:
an exhaust flow path; and
at least one sound attenuation structure disposed in the exhaust flow path, the at least one sound attenuation structure comprising:
a substantially rigid frame divided into a plurality of individual cells;
at least one flexible membrane retained by the substantially rigid frame; and
a mass operatively coupled to the at least one flexible membrane, wherein an absorption characteristic of the at least one sound attenuation structure is adjustable based on a weight of the mass, a flexibility of the at least one flexible membrane and a geometry of the substantially rigid frame.

19. The diffuser of claim 18, wherein the at least one flexible membrane comprises steel sheets.

20. The diffuser of claim 18, wherein the absorption characteristic comprises a resonant frequency of the at least one sound attenuation structure.
